(19) United States
(12) Patent Application Publication
(10) Pub. No.: US 2018/0370163 A1
(43) Pub. Date: Dec. 27, 2018

(54) PREFORM TOOL AND METHOD OF SHAPING COMPOSITE MATERIAL

(71) Applicant: BOMBARDIER INC., Dorval (CA)

(72) Inventors: Rheal BELISLE, Sainte-Anne-des-Plaines (CA); Louis FERNANDES, Laval (CA)

(21) Appl. No.: 16/061,797

(22) PCT Filed: Dec. 8, 2016
(86) PCT No.: PCT/IB2016/057444

§ 371 Date: Jun. 13, 2018

Related U.S. Application Data
(60) Provisional application No. 62/268,793, filed on Dec. 17, 2015.

(51) Int. Cl. B29C 70/54; B29C 70/46; B29D 99/00; B29C 51/08; B29C 51/14

(52) U.S. Cl. CPC B29C 70/545; B29C 70/46; B29L 2031/3082; B29C 51/082; B29C 51/14; B29D 99/0003

(57) ABSTRACT

A preform tool (30) for shaping uncured composite material, including a central section having a mold surface (40) corresponding to a surface of the desired component shape, and at least a first side section (34) detachably connected to the central section and having a support surface extending as a continuation of the mold surface, and a cover (36). The junction between the mold and support surface is located along an edge of the desired component shape. The cover is movable between an engaged position in proximity of the mold surface for retaining the composite material, and a disengaged position located further away from the mold surface than in the engaged position. Also, a method of shaping composite material includes conforming composite plies to the mold surface, disengaging each side section from the central section and trimming the excess composite material extending laterally from the mold surface.

### CROSS-REFERENCE TO RELATED APPLICATIONS

This application claims priority from U.S. provisional application No. 62/268,793 filed Dec. 17, 2015, the entire contents of which are incorporated by reference herein.

### TECHNICAL FIELD

The present application relates generally to the manufacture of composite components and, more particularly, to the shaping of uncured composite material prior to curing.

### BACKGROUND OF THE ART

When forming a composite structure including a skin and stiffeners, such as for example in the aerospace industry, the stringers may be shaped in their uncured state, then assembled to the uncured skin for co-curing.

The process of shaping the uncured stringers generally involves applying multiple plies of composite material on a male preform tool, and forming the plies to conform to a mold surface of the tool, through heating and/or reduced pressure application (vacuum). Once the plies are formed, they are generally transferred, for example by being supported in a female tool, to a trimming tool where excess composite material is trimmed. The shaped stringer is then disengaged from the trimming tool and assembled with the skin prior to curing. The forming process and manipulation required for trimming typically become more complex when the stringer is curved along its longitudinal direction, particularly when the stringer is curved along more than one direction. Shaping of uncured stringers for assembly can thus be time consuming, complex, and/or require relatively bulky and/or expensive equipment.

### SUMMARY

In one aspect, there is provided a preform tool for shaping uncured composite material to a desired component shape, the tool comprising: a central section including a mold surface having a shape corresponding to that of a surface of the desired component shape; a first side section detachably connected to the central section, the first side section having a support surface extending as a continuation of the mold surface of the central section; wherein a first junction between the mold surface of the central section and the support surface of the first side section is located along an edge of the surface of the desired component shape; and a cover having a surface complementary to the mold surface of the central section, the cover movable between engaged and disengaged positions, wherein with the cover in the engaged position, the surface of the cover is located in proximity of the mold surface of the central section for retaining the composite material thereagainst, and the cover in the disengaged position is located further away from the mold surface than in the engaged position.

In a particular embodiment, the central section includes first and second opposed sides with the mold surface extending between the opposed sides, the first side section detachably connected to the first side of the central section, the tool further comprising a second side section detachably connected to the second side of the central section and having a second support surface extending as a continuation of the mold surface of the central section, a second junction between the mold surface of the central section and the support surface of the second side section being located along a second edge of the surface of the desired component shape.

In a particular embodiment, the preform tool may include any one or any combination of the following:
the cover has first and second spaced apart side edge surfaces, the surface of the cover extending between the first and second side edge surfaces, the first edge surface is aligned with the first junction when the cover is in the engaged position, and the second edge surface is aligned with the second junction when the cover is in the engaged position;
the first side of the central section includes a first side surface extending from the first junction, the first side surface extending at a non-zero angle with respect to the mold surface at the first junction, and the second side of the central section includes a second side surface extending from the second junction, the second side surface extending at a non-zero angle with respect to the mold surface at the second junction;
the cover has first and second spaced apart side edge surfaces, the surface of the cover extending between the first and second side edge surfaces, the first edge surface of the cover extends as a continuation of the first side surface of the central section when the cover is in the engaged position, and the second edge surface of the cover extends as a continuation of the second side surface of the central section when the cover is in the engaged position;
the first side surface extends non-perpendicularly to the mold surface at the first junction, the second side surface extends non-perpendicularly to the mold surface at the second junction;
the first and second side surfaces include an anodized coating;
the mold surface of the central section is a male mold surface defined by a protuberance of the central section;
a pneumatic system connected to the cover and actuable to move the cover between the engaged and disengaged positions;
at least one heating element within the central section, the mold surface being in heat transfer relationship with the at least one heating element;
at least one temperature sensor receiving temperature data from the central section, and a control system configured to control the at least one heating element based on the temperature data.

In another aspect, there is provided a method of shaping composite material, the method comprising: providing a preform tool having a central section connected to at least one side section; conforming a plurality of stacked composite material plies to a mold surface of the central section of the preform tool, the stacked composite material plies defining excess composite material extending laterally from the mold surface and received on each of the at least one side section, the stacked composite material plies being in an uncured state; disengaging each of the at least one side section from the central section and from the stacked composite material plies; and with the stacked composite material plies retained against the mold surface, trimming the excess composite material extending laterally from the mold surface.

The at least one side section may include two side sections, the central section being received between and connected to two side sections.

Conforming the plurality of stacked composite material plies may include: stacking a plurality of prepreg plies away from the mold surface to form the stacked composite material plies; after stacking, disposing the plurality of stacked composite material plies on the mold surface of the preform tool; and applying heat and negative pressure to the stacked composite material plies until the stacked composite material plies conform to the mold surface; wherein the heat is applied by heating the central section internally.

The method may include measuring a temperature of the central section, and controlling the heat applied to the central section based on the measured temperature. The heat may be applied so as to maintain a temperature of the mold surface below 150° F.

The stacked composite material plies may include an epoxy resin and/or carbon fibers.

Trimming the excess material may be performed with a blade, and the method may further include moving the blade along a side surface of the central section to trim the excess material.

The stacked composite material plies may be retained against the central section by a cover having a surface complementary with the mold surface of the central section.

The method may further comprise, between conforming the plurality of stacked composite material plies to the mold surface and disengaging the side sections, applying negative pressure and heat to the stacked composite material plies to debulk the stacked composite material plies. The heat may be applied by heating the central section internally.

### DESCRIPTION OF THE DRAWINGS

Reference is now made to the accompanying figures in which:

FIG. 1a is a schematic tridimensional view of an aircraft;

FIG. 1b is a schematic cross-sectional view of a composite panel according to a particular embodiment, which can be used in an aircraft such as shown in FIG. 1;

FIG. 2 is a schematic tridimensional view of a preform tool for forming a stiffener of the composite panel of FIG. 1b;

FIG. 3 is a schematic front view of the preform tool of FIG. 2;

FIG. 4 is a schematic, bottom tridimensional exploded view of part of a central section of the preform tool of FIG. 2;

FIG. 5a is a schematic front view, partially in cross-section, of the preform tool of FIG. 2, illustrating a step in shaping a composite component with the preform tool;

FIG. 5b is a schematic front view, partially in cross-section, of the preform tool of FIG. 2, illustrating a further step in shaping a composite component with the preform tool; and

FIG. 5c is a schematic front view of the preform tool of FIG. 2, illustrating a further step in shaping a composite component with the preform tool.

### DETAILED DESCRIPTION

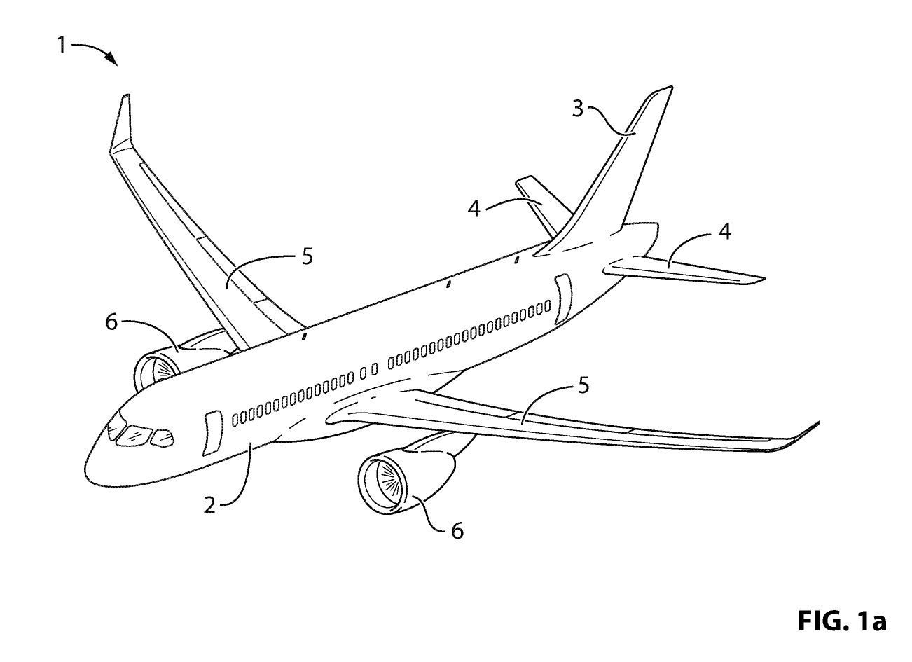

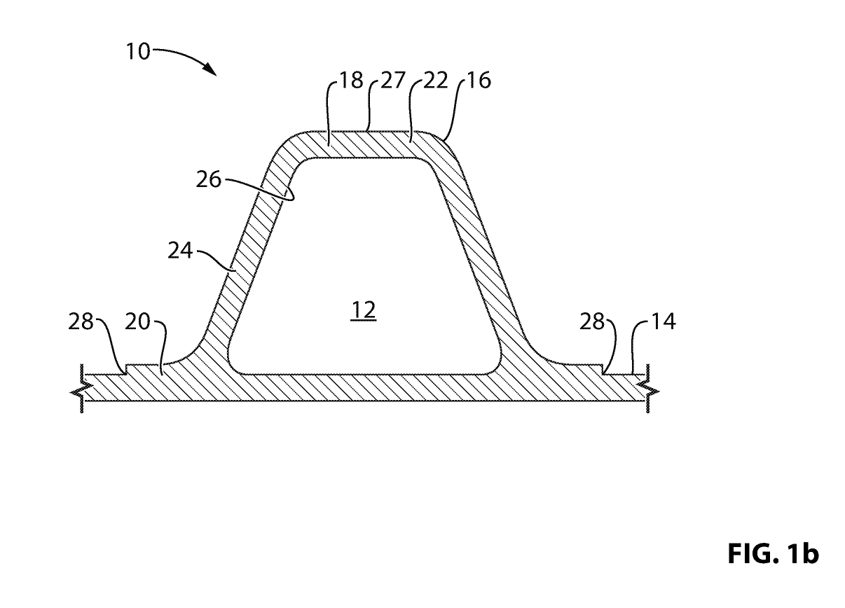

Referring to the drawings and more particularly to FIG. 1a, an aircraft is shown at 1, and is generally described to illustrate some components for reference purposes in the present disclosure. The aircraft 1 has a fuselage 2 having a fore end at which a cockpit is located, and an aft end supporting a tail assembly, with the cabin generally located between the cockpit and the tail assembly. The tail assembly comprises a vertical stabilizer 3 with a rudder, and horizontal stabilizers 4 with elevators. The tail assembly has a fuselage-mounted tail, but other configurations may also be used for the aircraft 1, such as cruciform, T-tail, etc. Wings 5 project laterally from the fuselage. The aircraft 1 has engines 6 supported by the wings 5, although the engines 6 could also be mounted to the fuselage 2. The aircraft 1 is shown as a jet-engine aircraft, but may also be a propeller aircraft.

Referring to FIG. 1b, a composite assembly 10 is shown. In this particular embodiment, the composite assembly 10 is a panel formed of two interconnected elements: a skin 14 and a stringer 16. The stringer 16 includes a body portion 18 extending between two foot portions 20, with each foot portion 20 extending in contact with the skin 14 and connected thereto. The body portion 18 is spaced apart from the skin 14 to define a stringer cavity 12. In the embodiment shown the stringer 16 has an omega (Ω) shape, with the body portion 18 including a central wall 22 extending parallel to or along the general direction of the skin 14, and angled side walls 24 extending from the central wall 22 to the foot portions 20, with a distance between the side walls 24 progressively increasing from the central wall 22 to the foot portions 20.

In a particular embodiment, the skin 14 is curved, and the composite panel 10 defines a section of the fuselage 2. Alternately, the composite panel 10 may define part of an internal bulkhead, part of the wing 5, or any other appropriate structural element of the aircraft 1, and/or the skin 14 and composite panel 10 may be flat. Although a single stringer 16 is shown, it is understood that the composite panel 10 may and typically does include a plurality of stringers 16 spaced apart from one another. In a particular embodiment, the stringer 16 extends longitudinally along only part of a corresponding dimension of the skin 14, i.e. the skin 14 extends in the longitudinal direction beyond the stringer 16. In another embodiment, the stringer 16 extends longitudinally along the entire corresponding dimension of the skin 14.

The stringer 16 and skin 14 are formed with composite material. Upon assembly, at least the stringer 16 is uncured with a stabilized geometry (referred to herein as “uncured”), i.e. having a matrix with a reduced viscosity without having been heated to the temperature point where polymerization typically starts (e.g., prepreg). In a particular embodiment, the skin 14 and stringer(s) 16 are both uncured with a stabilized geometry when assembled together, such as to be co-cured.

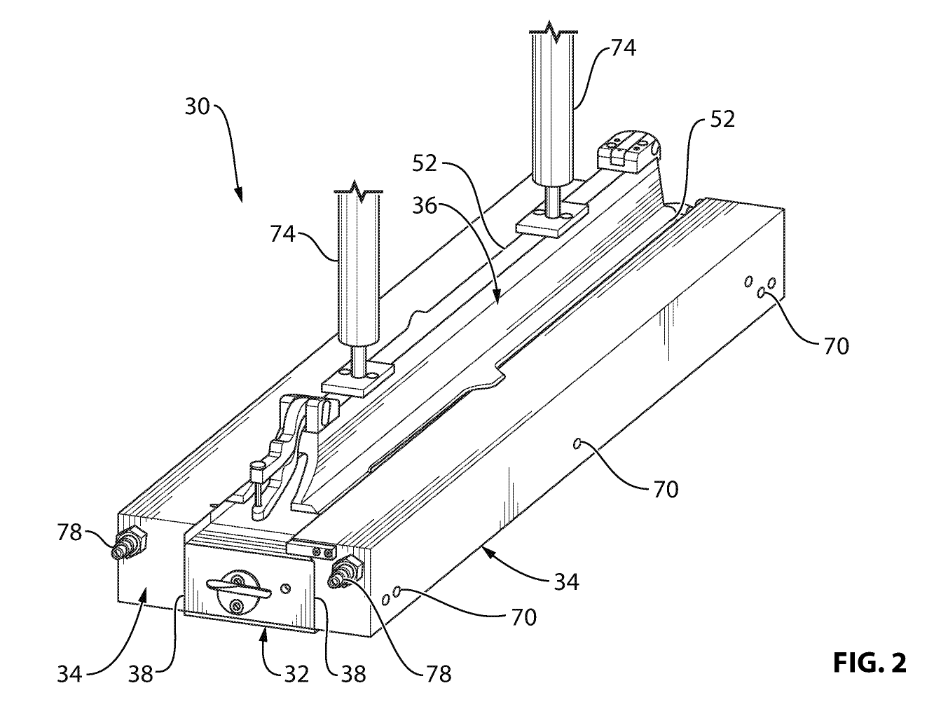

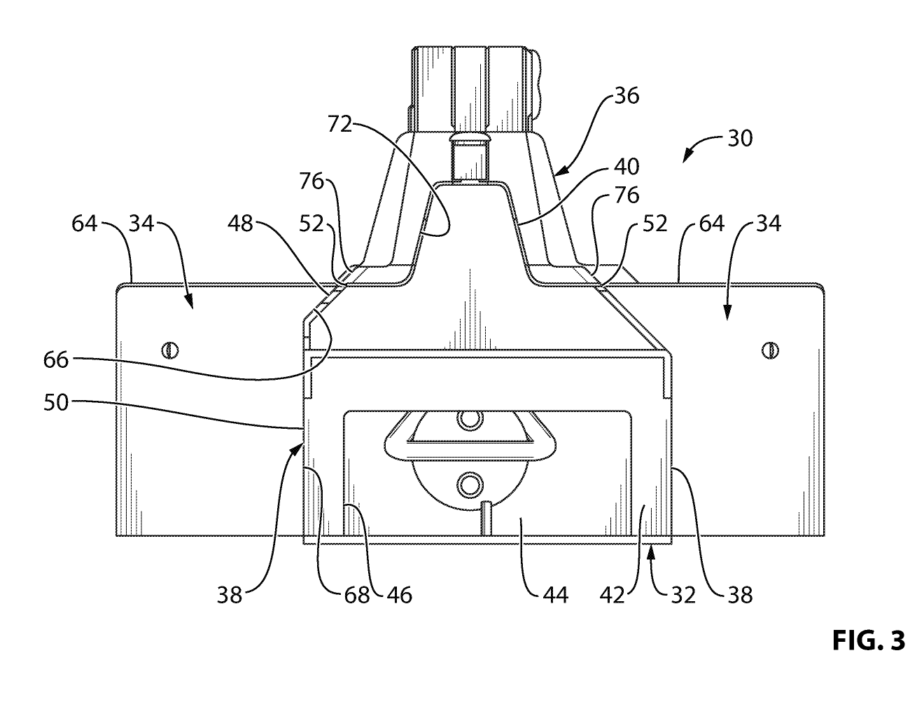

Before being assembled to the skin 14, the stringer 16 is shaped (formed and trimmed) to the desired configuration. FIGS. 2-3 show an exemplary embodiment of a preform tool 30 for performing such shaping of the stringer 16. It is understood that particular preform tool 30 shown herein is shaped for a particular stringer geometry and is shown as an example only; the configuration of the preform tool 30 may vary with the configuration of the stringer, or other composite component, being shaped.

The preform tool 30 is elongated, and generally includes a central section 32, two side sections 34 and a cover 36. The central section 32 includes opposed elongated sides 38, and a top mold surface 40 (see FIG. 3) extending between the opposed sides 38. The mold surface 40 has a shape corresponding to the desired shape of the inner surface 26 of the stringer 16 (see FIG. 1b). In the embodiment shown, the mold surface 40 thus defined a protuberance forming a male mold surface having a shape complementary to that of the stringer cavity 12.

Referring particularly to FIG. 3, each side 38 of the central section 32 defines an upper side surface 48 extending from a corresponding edge 52 of the mold surface 40, at a non-zero angle with respect to the portion of the mold surface 40 extending from that edge 52. In the embodiment shown, each upper side surface 48 extends non-perpendicularly to the adjacent portion of the mold surface 40; the upper side surfaces 48 are angled so as to move away from each other as the distance from the corresponding mold surface edge 52 increases. Each side 38 also includes a lower side surface 50 extending vertically. The upper side surfaces 48 are angled to facilitate trimming, as will be further described below. In a particular embodiment, the upper side surfaces 48 include an anodized coating.

Still referring to FIG. 3, the central section 32 includes an outer portion 42 and a removable inner portion 44. The outer portion 42 defines the two sides 38 of the central section 32 as well as the mold surface 40, and has an elongated open slot 46 defined along the bottom thereof. The removable inner portion 44 is complementary with and detachably received in the elongated slot 46.

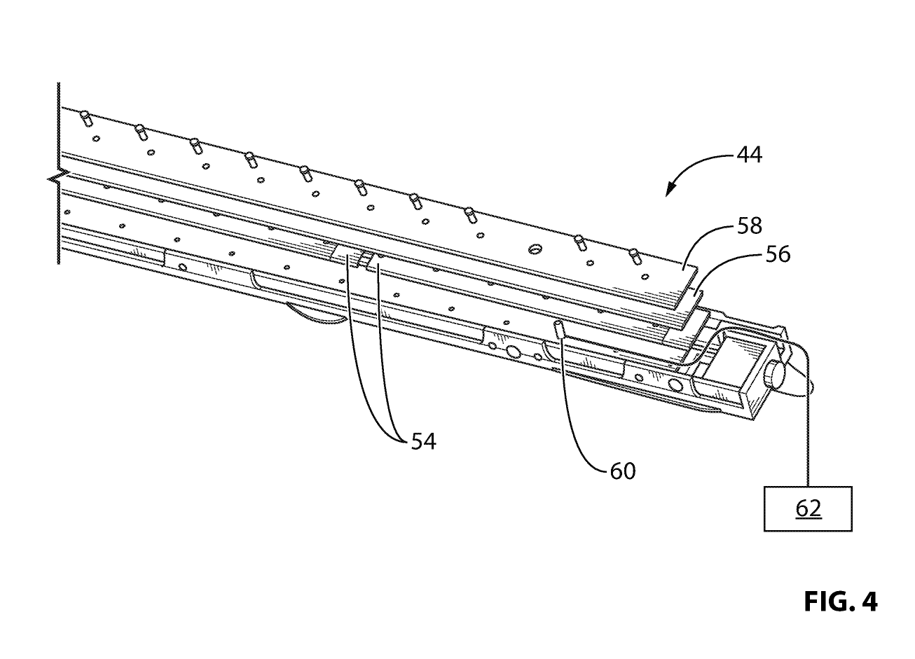

In a particular embodiment, the preform tool 30 is self-heating to facilitate hot forming. Referring to FIG. 4, the inner portion 44 of the central section 32 includes one or more heating elements, and the inner portion 44 is received in the outer portion 42 such that the mold surface 40 is in heat transfer relationship with the heating element(s); the inner heating elements thus heat the mold surface 40. In the embodiment shown, the heating elements include a plurality of heating blankets 54 received at the top of the inner portion 44, distributed along its length. Plates 56 made of insulating material are positioned under the heating blankets 54, and metal plates 58, which in a particular embodiment are made of aluminum, close the bottom of the inner portion 44 along its length. It is understood that any other type of suitable heating element may alternately be used, including, but not limited to, pipes embedded in the tool and receiving a hot fluid, infrared lamps, and isobar elements.

One or more temperature sensors, for example thermocouples 60, are provided in the central section 32 to monitor (directly or indirectly) the temperature of the mold surface 40; in the embodiment shown, thermocouples 60 are provided in the inner portion 44 of the central section 32, over the heating blankets 54. A control system 62 may be connected to the heating blankets 54 and thermocouples 60, to control the power in the heating blankets 54 based on the temperature data received from the thermocouples 60, for example such as to avoid exceeding a certain temperature to ensure that the composite material is not inadvertently cured during forming.

Still referring to FIG. 3, the two elongated side sections 34 of the preform tool 30 are spaced laterally from one another, and the central section 32 extends therebetween. Each of the side sections 34 is detachably connected to a respective side 38 of the central section 32. Each of the side sections 34 has a top support surface 64 that extends as a continuation of the adjacent portion of the mold surface 40. Each of the side sections 34 may include a handle at one or both ends thereof to facilitate movement of the side sections 34 when disengaged from the central section 32.

In the present specification including claims, the characterisation of a surface as extending as a continuation of another surface is intended to include surfaces that are aligned or substantially aligned, have the same or substantially the same angle at their junction, and are sufficiently close to one another so that no substantial discontinuity is provide in the shape defined by the two surfaces in cooperation.

The support surfaces 64 and mold surface 40 are suitably treated to be able to release composite material therefrom. For example, in a particular embodiment, the mold surface 40 and the part of the support surfaces 60 receiving the composite material are covered with a release film membrane before the composite material is received thereon.

In the embodiment shown, each of the side sections 34 has one side having an angled upper side surface 66 and a vertical lower side surface 68 which together define a side profile complementary to that of the adjacent side 38 of the central section 32. The side sections 34 may be detachably connected to the central section 32 through any suitable type of attachment mechanisms. For example, in a particular embodiment, the side sections 34 are connected to the central section 32 by a plurality of threaded fasteners 70 (see FIG. 2).

The two side edges 52 of the mold surface 40, or in other words the two junctions defined between the mold surface 40 and each support surface 64, are each located along a respective edge 28 of the stringer inner surface 26 (see FIG. 1 b) defined at the end of the respective foot portion 20, when the stringer is being formed on the mold surface 40. In other words, the mold surface 40 is configured such as to correspond in shape and dimension of the inner surface 26 of the stringer 16, from one edge 28 to the other edge 28. As can be seen in FIG. 2, the side edges 52 of the mold surface and corresponding junctions between the mold surface 40 and each support surface 64 may define grow-outs or indents if corresponding grow-outs or indents are required in the final shape of the stringer. Upon forming, composite material extending laterally beyond the mold surface 40 and onto the support surfaces 64 of the side sections 34 is excess material that is not required in the final shape of the uncured stringer.

Referring again to FIG. 3, the cover 36 has a bottom surface 72 complementary to the mold surface 40 of the central section 32. In the embodiment shown, the bottom surface 72 of the cover 36 thus defines a female mold surface having a shape corresponding to that of the outer surface 27 of the stringer 16 (see FIG. 1b). The cover 36 is moveable from an engaged position (as shown) to a disengaged position. In the engaged position, the bottom surface 72 of the cover 36 is located in proximity of the mold surface 40 of the central section 32, spaced apart therefrom a distance allowing for the composite material to be compressed against the central section 32 sufficiently for retention. For example, in a particular embodiment most of the bottom surface 72 of the cover 36 is spaced from the composite material, and the cover 36 contacts the composite material only adjacent and along the edges 52 to secure the edges of the stringer form in place. In the disengaged position, the cover 36 is moved away from the mold surface 40 sufficiently to allow the shaped stringer to be removed from the preform tool 30. In a particular embodiment, the disengaged position is above the engaged position, and the movement between the engaged and disengaged positions is a linear, vertical movement. It is understood that any other appropriate disengaged position and type of movement may alternately be used.

Referring back to FIG. 2, a pneumatic system includes pistons 74 connected to the cover 36. The pistons are actuable to move the cover 36 between the engaged and disengaged positions. Alternately, any other suitable actuation mechanism may be used, or the cover 36 may be manually movable between the two positions.

Referring again to FIG. 3, the cover 36 has on each side an elongated edge surface 76, and the mold surface 72 extends between the two side edge surfaces 76. In the embodiment shown, each of the edge surfaces 76 is aligned with the corresponding edge 52 of the mold surface 40 of the central section 32 (and also with the corresponding junction between the central section 32 and the adjacent side section 34). Each of the side edge surfaces 76 of the cover 36 is angled, and extends as a continuation of the adjacent upper side surface 48 of the central section 32 when the cover is in the engaged position. Accordingly, composite material extending laterally beyond the side edge surfaces 76 of the cover 36 is excess material that is not required in the final shape of the uncured stringer; the side edge surfaces 76 of the cover 36 are angled and positioned to facilitate trimming, as will be further described below.

The preform tool 30 can be used to form and trim the composite material, so as to shape the composite material into an uncured stringer ready for assembly with the skin. An example of a method of shaping composite material using the preform tool 30 is detailed below.

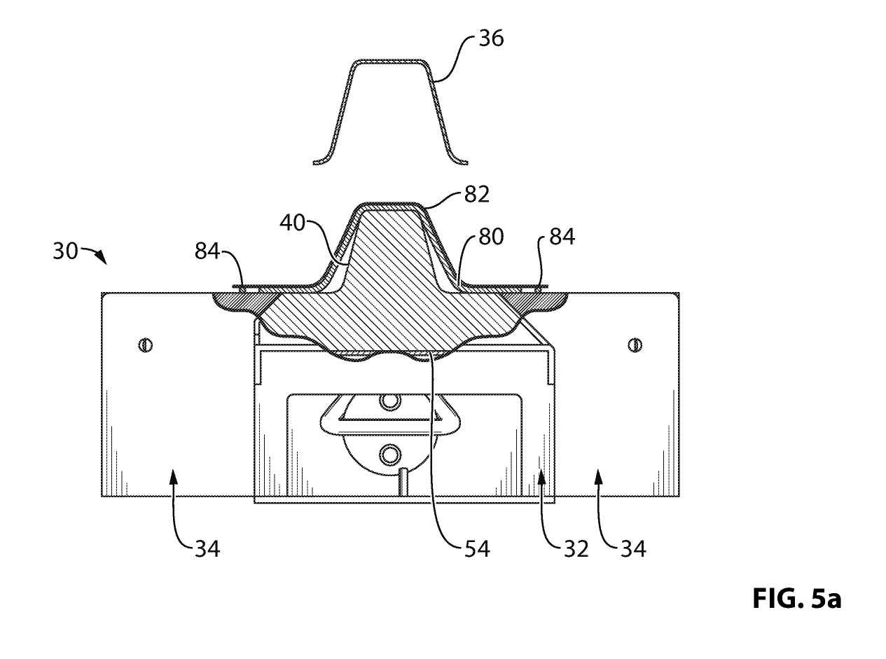

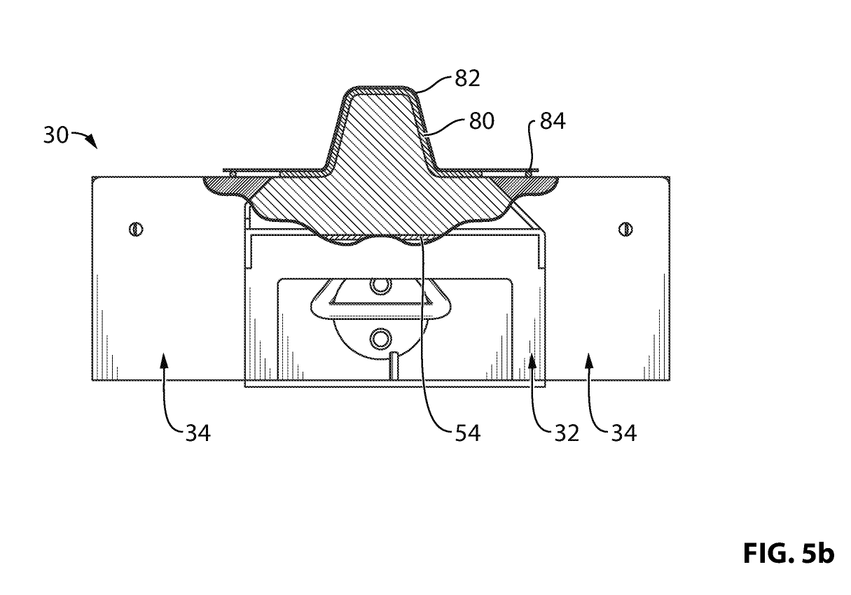

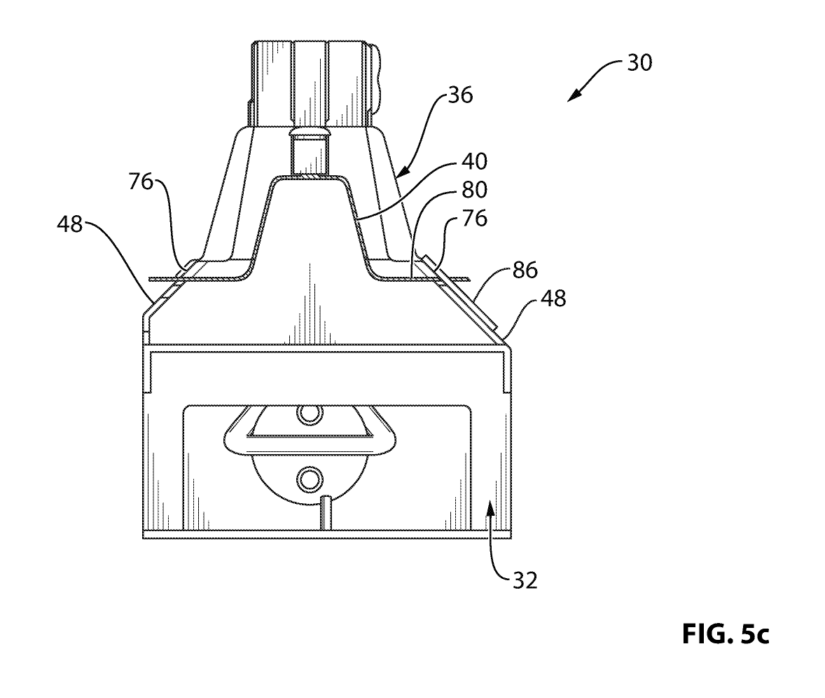

Referring to FIG. 5a, the preform tool 30 is assembled with the side sections 34 connected to the central section 32. The cover 36 is in the disengaged position. Uncured stacked composite material plies 80 are conformed to the mold surface 40 of the central section 32.

In a particular embodiment, each material ply is a ply of prepreg (pre-impregnated) composite material including fibers bonded by a matrix material having a stabilized geometry to facilitate handling, such that the matrix material becomes solid yet remains flexible and tacky. In a particular embodiment, the matrix material is a B-stage resin or a suitable thermoplastic material; any appropriate type of thermoset or thermoplastic matrix material may be used, including but not limited to epoxy resin, bismaleimide resin (BMI), phenolic resin, polyvinyl ester resin, polyether ether ketone (PEEK), polyphenylene sulphide (PPS), nylon, and poly ethylene (PE). Suitable fiber materials include, but not limited to, carbon fibers, glass fibers, and para-aramid (Kevlar®) fibers, and the fibers may be provided in any appropriate form including, but not limited, bi-directional fibers such as woven fabric and non-crimp fabric (NCF), and unidirectional fibers.

It is understood that some or all of the plies may include different fiber orientations from one another, and/or different materials from one another.

In the embodiment of FIG. 5a, the plies 80 of composite material are stacked one onto the other before being put on the mold surface 40, and away from the mold surface 40, for example with a flat configuration. In a particular embodiment, the stack includes 13 or 14 plies; other suitable number of plies may alternately be used. The flat stack of composite material plies 80 is disposed on the mold surface 40 of the preform tool 30. The stack has some flexibility allowing it to be bent to a configuration approaching, but not conforming to, the shape of the mold surface 40. Suitable bagging material 82 is engaged to the preform tool 30 to form a sealed enclosure containing the composite material, for example by engaging the bagging material 82 with any appropriate type of sealing material 84 (e.g. tacky compound, double faced tape) applied on the preform tool 30 and defining a perimeter around the composite material plies 80. The central section 32 is heated with the internal heating blankets 54 and the sealed enclosure is put under vacuum or negative pressure (i.e. reduced pressure with respect to that of the surrounding environment) using an appropriate vacuum system. Vacuum ports 78 may be provided in the side sections 34 (FIG. 2) to facilitate this process. In a particular embodiment, the reduced pressure is applied progressively as the stack of composite material plies 80 moves and deforms to conform to the shape of the mold surface 40, for example to reduce the risk of wrinkles. The heat and negative pressure are applied to the composite material plies 80 at least until they conform to the mold surface, as illustrated by FIG. 5b.

Once the plies conform to the mold surface, heat and reduced pressure can be applied to perform debulking of the plies (i.e. compacting and removing air and volatiles between the plies under moderate heat and vacuum to insure seating on the tool, prevent wrinkles, and/or promote adhesion).

Alternately, the composite material plies 80 may be stacked directly on the preform tool 30. The central section 32 of the preform tool 30 may be heated during the application of the first ply only, or alternately during the application of each ply. Debulking and compaction using negative pressure may be performed at regular intervals during application of the plies, with or without heating the central section 32; a bag is formed to enclose the composite material on the preform tool 30 as described above when the application of negative pressure is required, and removed for the stacking of the following plies.

Although not shown, it is understood that every time a sealed enclosure is defined to contain the composite material and apply negative pressure, the sealed enclosure is suitably prepared by adding the necessary additional materials such as for example breather material, barrier layers or release films impermeable or substantially impermeable to the matrix material of the composite (i.e. preventing or substantially preventing the matrix material from flowing therethrough during cure and releasable from the composite material after cure), reinforcement plies, etc. The preparation of a sealed enclosure for applying negative pressure to a composite material layup is well known and the selection and placement of the appropriate additional materials is within the common knowledge of the person of the art, and accordingly will not be discussed in detail herein.

Once the composite material is formed, trimming may be required to obtain the desired stringer shape. As mentioned above, any composite material extending laterally from the mold surface 40 and received on the side sections 34 is excess material not required in the final shape of the stringer. Referring to FIG. 5c, after forming of the plies, the side sections 34 are disengaged from the central section 32, and moved away so as to disengage the composite material plies 80 as well. The cover 36 is lowered in the engaged position to retain the composite material against the mold surface 40 during trimming. The cover 36 may be lowered before or after the side sections 32 are removed.

Still referring to FIG. 5c, with the cover 36 retaining the composite material plies 80 in place, the excess material extending laterally from the mold surface 40, and in the embodiment shown from the cover 36, is trimmed. In a particular embodiment, the central section 32 is also heated during trimming, such as to soften the resin of the composite material to facilitate trimming.

In the embodiment show, the angled and aligned side edge surfaces 76 of the cover 36 and upper side surfaces 48 of the central section 32 define a guide against which a blade 86 can slide, to guide cutting of the excess material. The blade 86 is moved along the length of the formed stringer, against the aligned surfaces 48, 76, until all of the excess material is removed and the desired final shape of the stringer is obtained.

During forming and trimming, the level of heat is maintained sufficiently low such as to avoid curing of the composite material. For example, in a particular embodiment where the composite material plies 80 include carbon fiber embedded in an epoxy resin, the temperature of the material is kept below 150° F. (85.6° C.); in a particular embodiment, the forming and debulking is performed a temperature of about 135° F.-140° F. (57.2° C.-60° C.) and the trimming at about 100° F. (37.8° C.). Other temperatures may be suitable; the selection of suitable temperatures depending on the type of composite material used is within the skill of the person of the art. The temperature of the mold surface 40 may be monitored by the temperature sensors (e.g. thermocouples 60), and controlled based on the sensor data by the control system 62. Alternately, manual control of the temperature may be performed.

After trimming, the composite material plies 80 define the shaped stringer 16. The stringer is disengaged from the preform tool 30. At this point, the stringer 16 is still uncured but is in a shape-retaining condition, namely due to compaction and debulking, such that it may be transported to be assembled to the skin 14. Before disengaging the shaped stringer 16 from the preform tool 30, a suitable support may be engaged to the shaped stringer 16 to help it maintain its shape, for example a tool having a female surface complementary to the outer surface 27 of the stringer 16 (e.g. inner mold line caul plate). The stringer 16 is then put in contact with the skin 14 under appropriate support, and the assembly 10 is co-cured through suitable application of heat and pressure.

The preform tool 30 can also be used to trim composite material after forming, without heating the material during trimming. When heating is not required, the internal heating elements (e.g. thermocouples 60) may be omitted.

In an embodiment where the stringer 16 is cured alone, for example prior to assembly to a skin 14, the preform tool 30 may be heated to a temperature sufficiently high so as to cure the composite material plies 80 after the composite material plies 80 have been formed to the desired shape on the mold surface 40. Trimming is preferably performed before curing, when the material can be cut more easily.

It is understood that although the stringer 16 has been shown with an omega shaped cross-section and the preform tool 30 has been shown with a shape corresponding to such a cross-section, the preform tool 30 can alternately be shaped to form stringers having other cross-sectional shapes, including, but not limited to, delta-shaped (Δ) cross-sections, and various open cross-sections such as T-shaped cross-sections, C-shaped cross-sections, L-shaped cross-sections and I-shaped cross-sections. For example, the preform tool 30 may include a single removable side section 34 where appropriate for a given stringer shape.

It is also understood that the preform tool 30 and method described herein can be used to shape other types of composite components, for example any reinforcing component that needs to be shaped in its uncured state.

The preform tool 30 thus advantageously provides for an all-in-one tool that, in a particular embodiment, forms, heats and permits precise trimming of composite material, allowing the steps required for the composite material to be configured in a desired shape, for example a stringer shape ready for assembly with a skin, to be performed on a single tool. Use of a single tool for multiple steps may allow for cost and/or time savings due to the reduced number of necessary tooling.

The preform tool 30 also allows for shaping of stringers (or other components) having a curved profile, where the longitudinal axis of the stringer is curved in a single direction, for example for assembly with a curved skin, or in multiple directions, for example for assembly with a curved skin and with additional curves and/or kinks along a direction different than that along which the curve of the skin is defined.

It is understood that any combination or sub-combination of the elements of the different embodiments is within the scope of this disclosure. While the methods and systems described herein have been described and shown with reference to particular steps performed in a particular order, it will be understood that these steps may be combined, sub-divided or reordered to form an equivalent method without departing from the teachings of the present invention. Accordingly, the order and grouping of the steps is not a limitation of the present invention.

Modifications and improvements to the above-described embodiments of the present invention may become apparent to those skilled in the art. The foregoing description is intended to be exemplary rather than limiting. The scope of the present invention is therefore intended to be limited solely by the scope of the appended claims.

1. A preform tool for shaping uncured composite material to a desired component shape, the tool comprising:
a central section including a mold surface having a shape corresponding to that of a surface of the desired component shape;
a first side section detachably connected to the central section, the first side section having a support surface extending as a continuation of the mold surface of the central section;
wherein a first junction between the mold surface of the central section and the support surface of the first side section is located along an edge of the surface of the desired component shape; and
a cover having a surface complementary to the mold surface of the central section, the cover movable between engaged and disengaged positions, wherein with the cover in the engaged position, the surface of the cover is located in proximity of the mold surface of the central section for retaining the composite material thereagainst, and the cover in the disengaged position is located further away from the mold surface than in the engaged position,
wherein the central section includes first and second opposed sides with the mold surface extending between the opposed sides, the first side section detachably connected to the first side of the central section, the tool further comprising a second side section detachably connected to the second side of the central section and having a second support surface extending as a continuation of the mold surface of the central section, a second junction between the mold surface of the central section and the support surface of the second side section being located along a second edge of the surface of the desired component shape;
the cover has first and second spaced apart side edge surfaces, the surface of the cover extending between the first and second side edge surfaces;
the first edge surface is aligned with the first junction when the cover is in the engaged position; and
the second edge surface is aligned with the second junction when the cover is in the engaged position.

2. (canceled)

3. (canceled)

4. The preform tool as defined in claim 1, wherein:
the first side of the central section includes a first side surface extending from the first junction, the first side surface extending at a non-zero angle with respect to the mold surface at the first junction; and
the second side of the central section includes a second side surface extending from the second junction, the second side surface extending at a non-zero angle with respect to the mold surface at the second junction.

5. The preform tool as defined in claim 4, wherein:
the cover has first and second spaced apart side edge surfaces, the surface of the cover extending between the first and second side edge surfaces;
the first edge surface of the cover extends as a continuation of the first side surface of the central section when the cover is in the engaged position; and
the second edge surface of the cover extends as a continuation of the second side surface of the central section when the cover is in the engaged position.

6. The preform tool as defined in claim 4, wherein:
the first side surface extends non-perpendicularly to the mold surface at the first junction;
the second side surface extends non-perpendicularly to the mold surface at the second junction.

7. The preform tool as defined in claim 4, wherein the first and second side surfaces include an anodized coating.

8. The preform tool as defined in claim 1, wherein the mold surface of the central section is a male mold surface defined by a protuberance of the central section.

9. The perform tool as defined in claim 1, further comprising a pneumatic system connected to the cover and actuable to move the cover between the engaged and disengaged positions.

10. The preform tool as defined in claim 1, further comprising at least one heating element within the central section, the mold surface being in heat transfer relationship with the at least one heating element.

11. The preform tool as defined in claim 10, further comprising at least one temperature sensor receiving temperature data from the central section, and a control system configured to control the at least one heating element based on the temperature data.

12. A method of shaping composite material, the method comprising:
providing a preform tool having a central section connected to at least one side section;
conforming a plurality of stacked composite material plies to a mold surface of the central section of the preform tool, the stacked composite material plies defining excess composite material extending laterally from the mold surface and received on each of the at least one side section, the stacked composite material plies being in an uncured state;
disengaging each of the at least one side section from the central section and from the stacked composite material plies; and
with the stacked composite material plies retained against the mold surface, trimming the excess composite material extending laterally from the mold surface.

13. The method as defined in claim 12, wherein the at least one side section includes two side sections, the central section being received between and connected to two side sections.

14. The method as defined in claim 12, wherein conforming the plurality of stacked composite material plies includes:
stacking a plurality of prepreg plies away from the mold surface to form the stacked composite material plies;
after stacking, disposing the plurality of stacked composite material plies on the mold surface of the preform tool; and
applying heat and negative pressure to the stacked composite material plies until the stacked composite material plies conform to the mold surface;
wherein the heat is applied by heating the central section internally.

15. The method as defined in claim 14, further comprising measuring a temperature of the central section, and controlling the heat applied to the central section based on the measured temperature.

16. The method as defined in claim 14, wherein the heat is applied so as to maintain a temperature of the mold surface below 150° F.

17. The method as defined in claim 12, wherein the stacked composite material plies include an epoxy resin.

18. The method as defined in claim 12, wherein trimming the excess material is performed with a blade, and the method further includes moving the blade along a side surface of the central section to trim the excess material.

19. The method as defined in claim 12, wherein the stacked composite material plies are retained against the central section by a cover having a surface complementary with the mold surface of the central section.

20. The method as defined in claim 12, wherein the stacked composite material plies include carbon fibers.

21. The method as defined in claim 12, further comprising, between conforming the plurality of stacked composite material plies to the mold surface and disengaging the side sections, applying negative pressure and heat to the stacked composite material plies to debulk the stacked composite material plies.

22. The method as defined in claim 21, wherein the heat is applied by heating the central section internally.
